(19) United States
(12) Patent Application Publication
(10) Pub. No.: US 2010/0004987 A1
(43) Pub. Date: Jan. 7, 2010

(54) Information-Processing System for the Purpose of Market Research

(75) Inventor: Dirk Leonard Benschop, Etten-Leur (NL)

Correspondence Address: THE WEBB LAW FIRM, P.C., 700 KOPPERS BUILDING, 436 SEVENTH AVENUE, PITTSBURGH, PA, 15219, US

(73) Assignees: GIGA MATRIX HOLDING B.V., Etten-Leur (NL); DLB FINANCE & CONSULTANCY B.V., Etten-Leur (NL)

(21) Appl. No.: 12/090,017

(22) PCT Filed: Oct. 8, 2006
(86) PCT No.: PCT/NL06/50250

§ 371 Date: Nov. 20, 2008

(30) Foreign Application Priority Data
Oct. 11, 2005 (NL) 1030162
Mar. 1, 2006 (NL) 1031268

(51) Int. Cl. G06Q 30/00; G06Q 10/00; G06F 15/16

(52) U.S. Cl. 705/14.13; 705/14.14; 705/14.19; 705/14.2; 705/14.37; 709/206

(57) ABSTRACT

An information-processing system for market research includes a number of stations connected to the computer, each desirably having a touch screen. The program available in the computer is adapted to output a series of questions to a respondent, optionally after providing beforehand information necessary to answer a question. Once the respondent has answered the group of questions, the respondent receives a free reward, such as a gift voucher or product, for example. By presenting product information about which questions are asked, the invention ensures that each respondent has viewed the provided information before the respondent can receive their reward.

The invention relates to an information-processing system, comprising:

a central computer;

at least one station connected thereto, comprising:
information input means such as a keyboard, a display with a mouse, a touch screen or a mobile telephone;
information output means such as a display;
product output means;
program means in which a program is present.

Such a system is known and is used for market research. Consumers are given the opportunity to answer questions about products or services of clients of a market research agency via a website of the market research agency by making use of their own PC.

The response of the respondents is limited. The cause of this lies in the low motivation of many people to use their time in a manner which is advantageous only to others, in particular the market research agency and the clients.

The invention has for its object to provide an information-processing system, in particular for market research purposes, in which the response can be dramatically higher than in existing and known systems.

In this respect the invention provides an information-processing system of the type stated in the preamble, which has the feature that the program is adapted to have the information input means and/or the information output means and the product output means perform the following steps, in suitable sequence, of:

(a) asking a respondent a question via the information output means during a session after voluntary registration and identification of the respondent;

(b) processing the answer given by the respondent to the question via the information input means;

(c) repeating steps (a) and (b) a determined number of times;

(d) having the information output means announce a first free reward, for instance a first course;

(e) dispensing of the announced first reward there and then by the product output means.

Exploratory, confidential research has shown that the predicted response of practically 100% can indeed be realized. The practical efficiency of the information-processing system according to the invention can hereby be characterized as absolutely superior relative to existing systems.

Potential respondents can be recruited effectively in a campaign via the media suitable for this purpose such as radio, television, internet, newspapers, magazines and mobile phone systems.

The starting point is that each respondent takes part on a completely voluntary basis. After registering, the respondent can take a seat at a table where a station is located of the described type and with the described functional components. The session can then begin by the respondent carrying out an operation suitable for the purpose. In particular, the respondent can click a “START” button, whereafter he/she is welcomed and is presented with the first question. After answering this, he/she is given a second question, and so on. This first series of questions may relate to his/her personal profile, such as further information regarding address, date of birth, nationality, civil status, number of children, profession, education, shops where the respondent shops regularly, and the like.

Once the respondent has answered the questions posed, he is offered a first free reward and then given this there and then. It is for instance possible here to envisage a first course.

It is noted that the product output means can form part or even coincide with the information output means. As example is given the application of the information-processing system according to the invention in a hairdressing salon. The customer sits still in a seat for a longer period of time during hairdressing and in these circumstances is in a very good position to participate in a session of the system according to the invention. The announcement of the first free reward could be a message on the screen that the participating customer is entitled to his/her reward. This can for instance consist of a discount on the hairdressing, a free product or the like. This announcement as according to step (d) then coincides in principle with step (e), i.e. the first free reward. The staff will then be responsible for making sure that the reward displayed on the screen is given in appropriate manner.

The product output means can be deemed in this embodiment as provisions which supply an immaterial product which is based on the operation of the information output means and which serves to ensure the customer that the staff of the hairdressing salon will provide a reward in kind, a discount or the like.

It will be apparent that this is only an example.

In a further development, the system according to the invention has the special feature that the program is also adapted to perform the following steps, in suitable sequence, of:

(f) presenting an advertisement with information relating to products and/or services of a client via the information output means;

(g) optionally presenting an information-free display, such as a blank screen, for some time via the information output means;

(h) asking the respondent a question via the information output means about the information presented in step (f);

(i) processing the answer given by the respondent via the information input means;

(j) repeating the steps (h) and (i) a number of times;

(k) announcing a second free reward, for instance a main course, with the information output means;

(l) dispensing the announced second reward there and then with the product output means;

(m) asking the respondent a number of questions via the information output means about the reward dispensed in step (l);

(n) processing the answers given by the respondent via the information input means.

With this further development the market research agency, the operator of the information-processing system, can gain further insight into the opinion of, and purchasing behaviour relating to, products and/or services of the relevant client. The respondent will be motivated to answer the questions since he/she is being offered a free reward, which he/she knows will be given to him/her there and then once this part of the session has ended.

The second reward can for instance be a main course.

If enough time still remains and the respondent is still prepared to answer more questions, he/she can then be presented with a second series of questions, for instance relating to an extension of his personal profile and/or a further advertisement or series of advertisements, to which he can respond on the basis of questions asked about them.

Once the session relating to content is completed as according to the foregoing, according to one option the system can respond further in order to finish the session correctly to the satisfaction of the respondent. For this purpose the system can for instance have the special feature that the program is adapted to have the information input means and/or the information output means and the product output means perform the following steps, in suitable sequence, of:

(o) thanking the respondent and announcing the final reward, for instance a package with one or more gifts, with the information output means;

(p) having the announced final reward dispensed by the product output means or a separate dispensing station.

The gifts can for instance be sample packages with products which are associated with the questions put to the respondent.

The more data the respondent adds to his personal profile in response to questions put to him/her, the more he/she contributes toward the appreciation he will receive for his co-operation. He/she can for instance increase the chances of being invited to a free meal, entertainment or the like.

In a preferred embodiment the system has the special feature that upon first identification and registration a respondent is provided with an electronically readable, personal card, and that a card reader for identifying the respondent by means of the personal card is disposed at the entrance to the space where a number of stations are situated, or a card reader is added to each station.

Fraud can hereby be prevented by means of an identity check upon entry and/or registration.

In a specific variant the system has the special feature that the information output means comprise a 3D virtual reality system with 3D-glasses, which system presents an advertisement as according to step (f) in virtual reality, for instance containing information about travel or entertainment.

New products and services can hereby be experienced in virtual reality in an “experience room” by means of 3D-glasses. On the basis of this information the system can ask the respondent further questions for answering.

The system preferably makes use of a touch screen which can perform the function of both information input means and information output means.

In a variant the system has the special feature that the program is adapted to have the information input means and/or the information output means and the product output means perform the following steps, in suitable sequence, of:

(q) performing steps (b) and (e) such that the first reward is a gift voucher or discount voucher.

In this case the gift voucher or discount voucher, just as for instance a course, is given as reward to the respondent there and then. For this purpose the product output means can comprise a dispensing device, comparable to a cash dispenser, suitable for dispensing a voucher, or a printer.

In a specific embodiment the system according to the invention has the special feature that a station comprises:

product input means for collecting waste products such as packages, bottles and/or batteries to be handed in by a respondent.

When waste products are handed in, the balance of the personal card is topped up. The associated increased value can for instance be manifested in a greater chance of the respondent qualifying for a meal, entertainment or the like. The motivation of the respondent here also lies in his being completely voluntary and the free reward, for instance a voucher for a meal or a theatre performance, which is presented to him there and then. It can generally be the case that the reward increases as the information provided by the respondent becomes more extensive. The system according to the invention can in this respect have the special feature that the questions in step (c) relate to the personal profile of the respondent and the reward in steps (d) and (e) increases in value as the number of answers given by the respondent in step (b) increases.

The system can also have the special feature that the reward consists of the chance of the respondent receiving a relatively large reward, for instance an invitation for a meal, a theatre performance or other form of entertainment, this chance increasing as the number of answers given by the respondent in step (b) increases.

The system according to the invention can further have the feature that anyone can register with the system as aspirant respondent via a reply form connected to the computer on the website of the operator of the system, or via a postal address.

Other ways of registering are also possible. An aspirant respondent can for instance register at a centre where a space with a number of stations is situated. In this case the available staff will record the details of the aspirant respondent in order to effect his/her registration.

The system can further have the special feature that the personal card can be inserted in the card reader after a session, and is topped up therein with an amount related to the number of answers given by the respondent.

The system according to the invention is intended for the purpose of carrying out market research with a high efficiency. For this reason the system is preferably embodied such that the program is adapted to have the information input means and/or the information output means and the product output means perform the following steps, in suitable sequence, of:

(n) processing the answers of a number of respondents into commercially useful information in the manner of a market study and providing clients with information desired by these clients.

The system can optionally have the special feature that the computer is connected on-line to one or more clients, who can monitor a session in real time and can put additional questions to the relevant respondent. This option makes it possible for clients to intervene at a relatively low level in a research session. With this variant a client can monitor the course of a session in real time in his own office, and optionally add extra questions which may arise with a specific respondent during a session.

The final research report can be delivered digitally to the client, for instance in SPSS or ASCI format.

The system can also comprise: optionally adjustable mood management means for influencing the state of mind of a respondent during a session on the basis of influencing parameters from the group which includes:

optical effects such as the colour(s) of projected light and/or projected patterns;

odours such as the smell of flowers, herbs, fruit or fragrant food;

temperature;

acoustic effects such as music or restful sounds; and

furnishing of the space where a session takes place.

With such a variant the state of mind of a respondent can be influenced in a highly positive way. It is expected that this will improve his/her motivation and the involvement of the respondent in the research, and thereby the quality of the results thereof.

The stated embodiment can optionally have the special feature that the furnishing of said space can be varied in modular manner. In this respect it is possible to envisage that, for instance in a session specially for children, the furniture is adjusted to the size of children and particularly comprises smaller units such as chairs, tables and so on. For a session with tall or corpulent respondents the furniture can also be adapted to this group of respondents, in particular have greater heights or greater widths respectively.

The invention further relates to a dispensing machine for free products, comprising an information-processing system as according to any of the foregoing specifications, in which the product output means are adapted to allow the relevant respondent to make a selection, by means of selection means, from the products on offer after giving a chosen number of answers to a series of set questions, after operation of which selection means the product output means dispense the selected product free of charge.

The invention will now be elucidated with reference to the accompanying drawings. These show the display on a touch screen at successive stages of a session.

In the drawings:

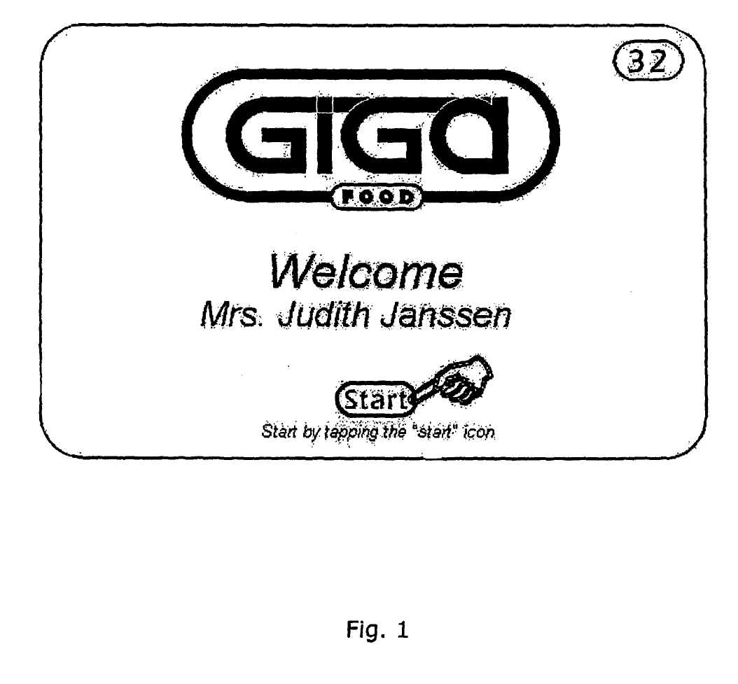

FIG. 1 shows a welcome screen;

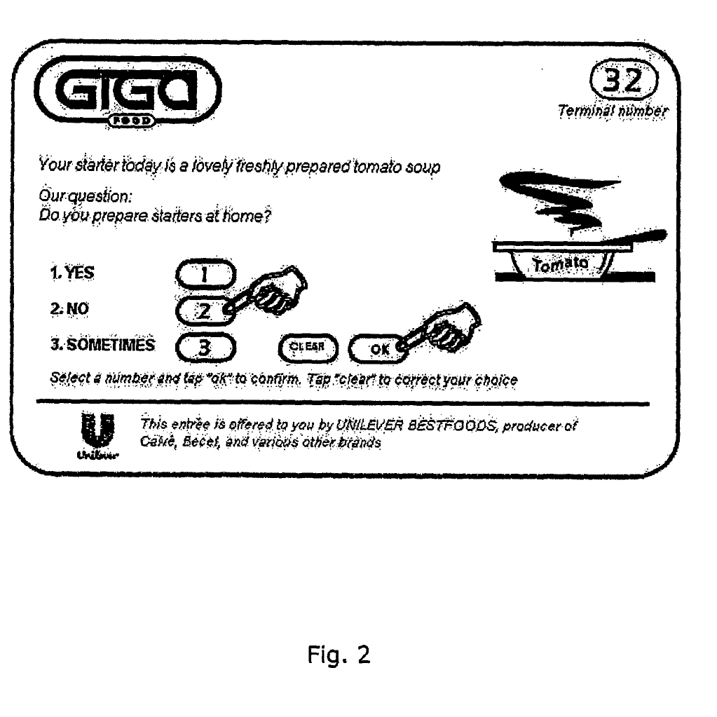

FIG. 2 shows a screen with a question and a number of answer buttons;

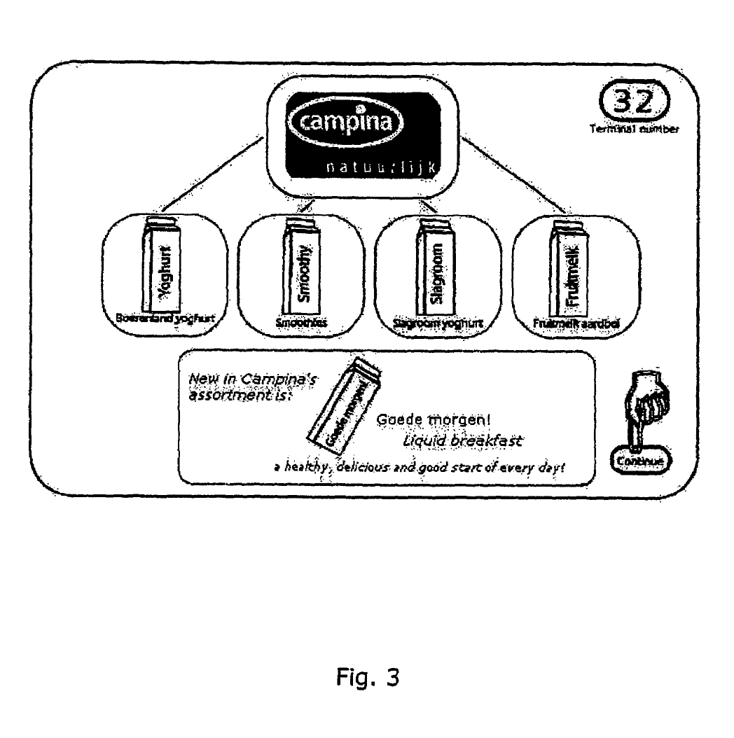

FIG. 3 shows a screen with an advertisement;

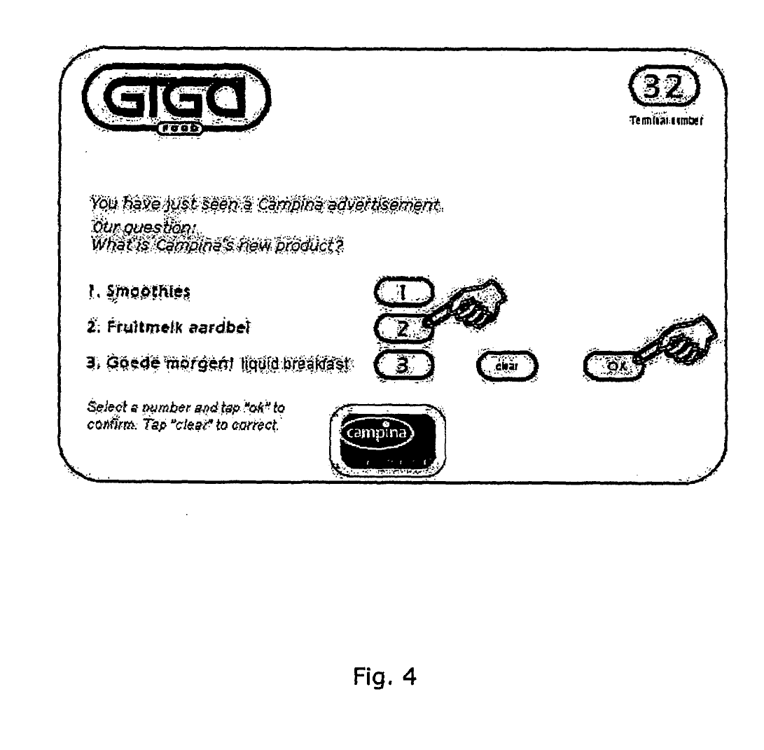

FIG. 4 shows a screen with a question relating to the advertisement shown in FIG. 3 and a number of answers with associated buttons;

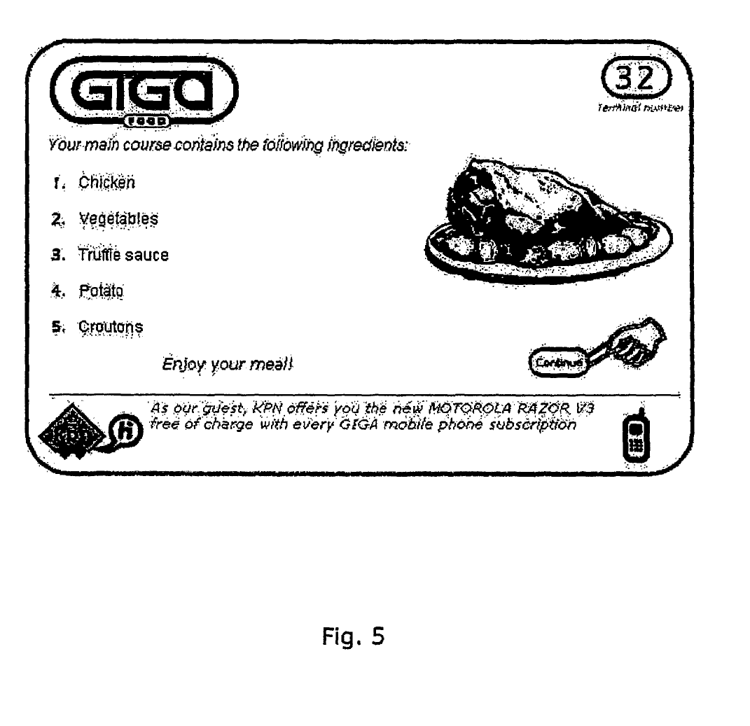

FIG. 5 shows a screen relating to the main course offered as free reward;

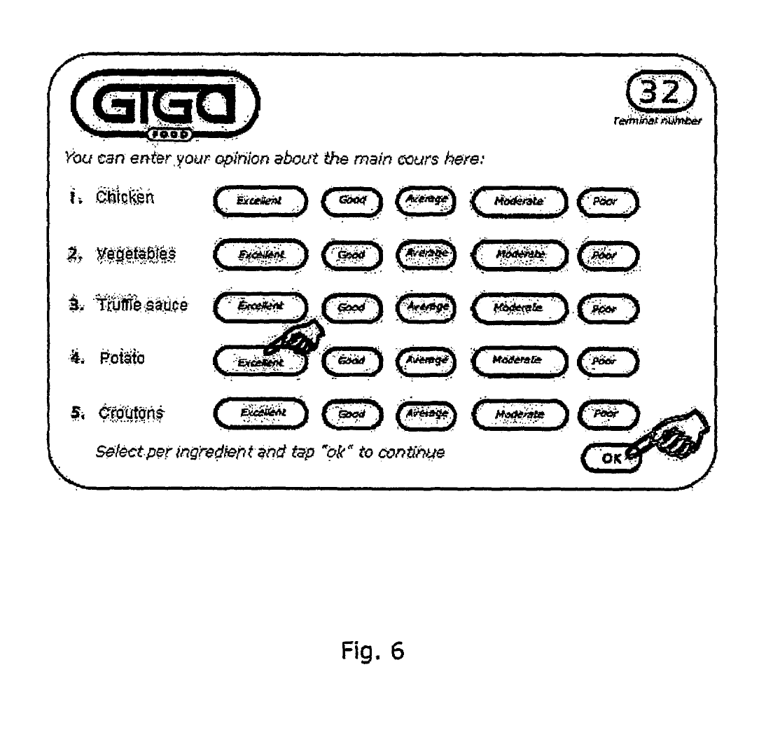

FIG. 6 shows a screen with questions and answer buttons relating to the components of the main course; and

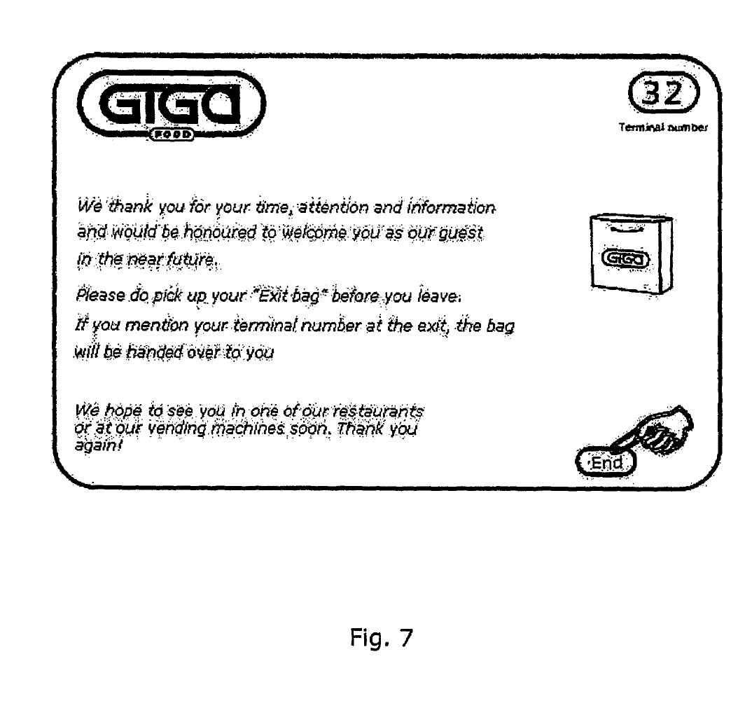

FIG. 7 shows a final screen with which the session is closed.

FIG. 1 shows a welcome screen in which the respondent, who has made his/her identity known by inserting his/her personal card in a card reader, is welcomed. Through pressing of the “START” button the program begins carrying out the successive steps, wherein a start is made with a number of questions.

FIG. 2 shows a first question. The possible answers are indicated in multiple choice with associated buttons.

In this case information is given first relating to a product which the respondent knows he/she will receive after answering a first series of questions. The information is: “Your first course today is a delicious, fresh tomato soup.”

The question is: “Do you eat first courses at home?”.

Possible answers are: (1) yes, (2) no, (3) sometimes. After keying in the chosen answer, the respondent can still correct the answer by means of a restore button, or confirm his/her choice by means of an “OK” button. The system then moves on to the following question or the subsequent part of the session.

It is important to note that there is an advertisement on the underside of the screen in FIG. 2. In this case the advertisement is from Unilever: “Your first course is presented to you by Unilever Best Foods. Known for Iglo, Mora, Becel, Calvé etc.”

After answering the first five question of this type, the respondent receives a signal that the first course will be served. This therefore actually takes place immediately after the relevant announcement.

FIG. 3 shows an advertisement with a number of known products and the announcement of a new product.

A blank screen will preferably follow for a time after this screen. FIG. 4 shows the subsequent screen, which refers to the advertisement of FIG. 3. This screen tests the concentration of the respondent. Here too there are three possible answers with a restore button and confirmation button.

It is very important to note that a 100% response of the respondents to the advertisement in question is guaranteed with this system. This is a unique feature of the system according to this invention.

FIG. 5 shows a screen which indicates the composition of the main course which can be expected as reward. After ten questions have then been answered by the respondent, the respondent receives the message on the screen that the announced main course is about to be served.

Since the screen according to FIG. 5 does not contain any questions, it is left to the respondent to press the “NEXT” button after reading the relevant information, whereby the system goes to the following screen.

FIG. 6 shows a screen in which the respondent, who has by now had the opportunity to eat his/her main course, can give his/her opinion about the different components of the main course with a characterization “very good”, “good”, “mediocre”, “very mediocre”, “poor”.

Once all the questions have been answered, the respondent pushes the confirmation button “end”, whereby the part of the session relating to content is ended.

FIG. 7 shows that the system, as an end to the session, thanks the respondent for his/her valuable contribution. It is also announced that the respondent can obtain an exit bag at the exit. For this purpose he/she must state his/her participant number, which corresponds with the number of the station, in this case terminal number 32 (top right on each screen).

It will be apparent that the system according to the invention offers a respondent the possibility of sharing his valuable information with interested parties in a manner which is very pleasant and relaxed for respondents. For doing this the respondent receives rewards in every conceivable form.

Many embodiments can be envisaged of the location points for stations. It is possible to envisage a space with an haute cuisine restaurant specially set up for the system, for instance with 12 tables for a total of 50 people. Sampling takes place at the entrance and the exit, use is made of touch screens, mood management for positively influencing the frame of mind. The atmosphere can be modified for this purpose very rapidly and under software control by means of optical and acoustic illusions.

Another embodiment can be seen in a vending machine positioned at a chosen location. The dispensing of food and/or goods can take place on the basis of answers to questions on a touch screen. Alternatively, gift vouchers or credit vouchers can also be dispensed.

The stations can be positioned at any suitable location, for instance in an own establishment, in a catering establishment, in a video shop and so on.

It will be apparent that the figures give only a very limited representation of the diverse information screens during a session. It is possible to envisage a session which takes up some considerable time, for instance several hours, and that the number of screens will therefore be in the order of many tens and even up to over a hundred.

1-19. (canceled)

20: An information-processing system, comprising:
a central computer;
at least one station connected to the central computer and comprising:
information input means comprising one of a keyboard, a display with a mouse, a touch screen, and a mobile telephone;
a display;
product output means;
a program configured to have at least one of the information input means, the display, and the product output means perform the steps of:
(a) asking a respondent a question via the display during a session after voluntary registration and identification of the respondent;
(b) processing an answer given by the respondent to the question via the information input means;
(c) repeating steps (a) and (b) a predetermined number of times;
(d) having the display announce a first free reward; and
(e) dispensing of the announced first reward by the product output means.

21: The information-processing system as claimed in claim 20, wherein the program is further configured to perform the steps of:
(f) presenting an advertisement with information relating to products or services of a client via the display;
(g) optionally presenting a blank screen for some time via the display;
(h) asking the respondent a question via the display about the information presented in step (f);
(i) processing the answer given by the respondent via the information input means;
(j) repeating the steps (h) and (i) a predetermined number of times;
(k) announcing a second free reward with the display;
(l) dispensing the announced second reward with the product output means;
(m) asking the respondent a number of questions via the display about the reward dispensed in step (l); and
(n) processing the answers given by the respondent via the information input means.

22: The information-processing system as claimed in claim 20, wherein the program is configured to have at least one of the information input means, the display, and the product output means perform the steps of:
(o) thanking the respondent and announcing the final reward with the display; and
(p) having the announced final reward dispensed by the product output means or a separate dispensing station.

23: The information-processing system as claimed in claim 20, wherein the program is configured to have at least one of the information input means, the display, and the product output means perform the step of:
(q) performing steps (b) and (e) such that the first reward is a gift voucher or a discount voucher.

24: The information-processing system as claimed in claim 21, wherein the program is configured to have at least one of the information input means, the display, and the product output means perform the step of:
(r) performing steps (k) and (l) such that the second reward is a gift voucher or a discount voucher.

25: The information-processing system as claimed in claim 21, wherein the program is configured to have at least one of the information input means, the display, and the product output means perform the step of:
(s) repeating steps (f) up to and including (n) with a different advertisement.

26: The information-processing system as claimed in claim 25, wherein the program is configured to have at least one of the information input means, the display, and the product output means perform the step of:
(t) repeating step (s) a predetermined number of times.

27: The information-processing system as claimed in claim 20, further comprising product input means for collecting waste products to be handed in by the respondent.

28: The information-processing system as claimed in claim 20, further comprising a card reader for identifying the respondent by electronically reading a personal card of the respondent.

29: The information-processing system as claimed in claim 20, wherein the questions in step (c) relate to a personal profile of the respondent and the reward in steps (d) and (e) increases in value as the number of answers given by the respondent in step (b) increases.

30: The information-processing system as claimed in claim 29, wherein the reward includes the chance of the respondent receiving a large reward, wherein the chance increases as the number of answers given by the respondent in step (b) increases.

31: The information-processing system as claimed in claim 20, wherein an aspirant respondent is allowed to register with the system via a reply form connected to the computer on a website of an operator of the system, or via a postal address.

32: The information-processing system as claimed in claim 28, wherein the personal card is adapted to be inserted in the card reader after a session, and is topped up therein with an amount related to the number of answers given by the respondent.

33: The information-processing system as claimed in claim 21 wherein the information output means comprise a 3D virtual reality system with 3D-glasses, wherein the system presents an advertisement as according to step (f) in virtual reality.

34: The information-processing system as claimed in claim 21, wherein the program is further configured to process the answers of a number of respondents into commercially useful information in the manner of a market study and providing clients with information desired by these clients.

35: The information-processing system as claimed in claim 34, wherein the computer is connected on-line to one or more clients, to allow the one or more clients to monitor a session in real time and ask additional questions to the relevant respondent.

36: The information-processing system as claimed in claim 20, further comprising adjustable mood management means for influencing the state of mind of a respondent during a session on the basis of influencing parameters, wherein the influencing parameters are one or more of:
optical effects including one or more colors of projected light or projected patterns;
odors;
temperature;
acoustic effects; and
furnishing of the space where a session takes place.

37: The information-processing system as claimed in claim 36, wherein the furnishing of said space is adapted to be varied in a modular manner.

38: A freely disposable dispensing machine for free products, comprising an information-processing system including:
a central computer;
at least one station connected to the central computer and comprising:
information input means comprising one of a keyboard, a display with a mouse, a touch screen, and a mobile telephone;
a display;
product output means;
a program configured to have at least one of the information input means, the display, and the product output means perform the steps of:
(a) asking a respondent a question via the display during a session after voluntary registration and identification of the respondent;
(b) processing an answer given by the respondent to the question via the information input means;
(c) repeating steps (a) and (b) a predetermined number of times; and
(d) having the display announce a first free reward, wherein the product output means are configured to allow the relevant respondent to make a selection via selection means from products on offer after the respondent has given a chosen number of answers to a series of set questions, wherein the product output means is configured to dispense the selected product free of charge thereafter.
